(19) United States
(12) Patent Application Publication
(10) Pub. No.: US 2017/0200325 A1
(43) Pub. Date: Jul. 13, 2017

(54) DIAGNOSTIC TEST PERFORMANCE CONTROL SYSTEM AND METHOD

(71) Applicant: Ford Global Technologies, LLC, Dearborn, MI (US)

(72) Inventors: Pankaj Kumar, Dearborn, MI (US); Hassene Jammoussi, Canton, MI (US); Imad Hassan Makki, Dearborn Heights, MI (US)

(73) Assignee: Ford Global Technologies, LLC, Dearborn, MI (US)

(21) Appl. No.: 14/994,568

(22) Filed: Jan. 13, 2016

(51) Int. Cl. G07C 5/00; G07C 5/08

(52) U.S. Cl. CPC G07C 5/008; G07C 5/0808; G07C 5/085

(57) ABSTRACT

A cloud-based server is communicatively coupled to vehicle computing devices and is programmed to receive a first fault message transmitted from a first vehicle, the first fault message providing data to indicate an unsuccessful performance of a first diagnostic test, such as an onboard diagnostic (OBD) test, in the first vehicle and one or more vehicle operating conditions during the unsuccessful performance of the first diagnostic test in the first vehicle. The server is further programmed to determine, from the one or more vehicle operating conditions, one or more required conditions for an expected successful performance of the first diagnostic test and generate a first performance message to communicate the one or more required conditions for the expected successful performance of the first diagnostic test.

### BACKGROUND

On-board diagnostic (OBD) tests analyze vehicle operations and may identify problems with vehicle components. Examples of OBD tests include an evaporative emissions control (EVAP) test, an exhaust gas recirculation (EGR) test, an oxygen sensor test, a threshold catalyst test, etc. Performance of OBD tests often depends on satisfying prerequisite (sometimes referred to as entry) conditions before and/or during the tests. However, OBD tests may be unsuccessfully performed—e.g., being cut-off, generating inaccurate results, generating inconclusive results, etc.—under certain variable conditions. Unsuccessful performance of OBD tests reduces the efficiency of vehicle operations, as OBD tests may require a substantial amount of energy and operating resources to perform.

### DRAWINGS

FIG. 1 illustrates an example system for diagnostic test performance control including a remote computing system and multiple vehicles.

FIG. 2 is a diagram of an example process for remotely generating a performance message for a diagnostic test.

FIG. 3 is a diagram of an example process for controlling diagnostic tests in a vehicle.

### DETAILED DESCRIPTION

### System Overview

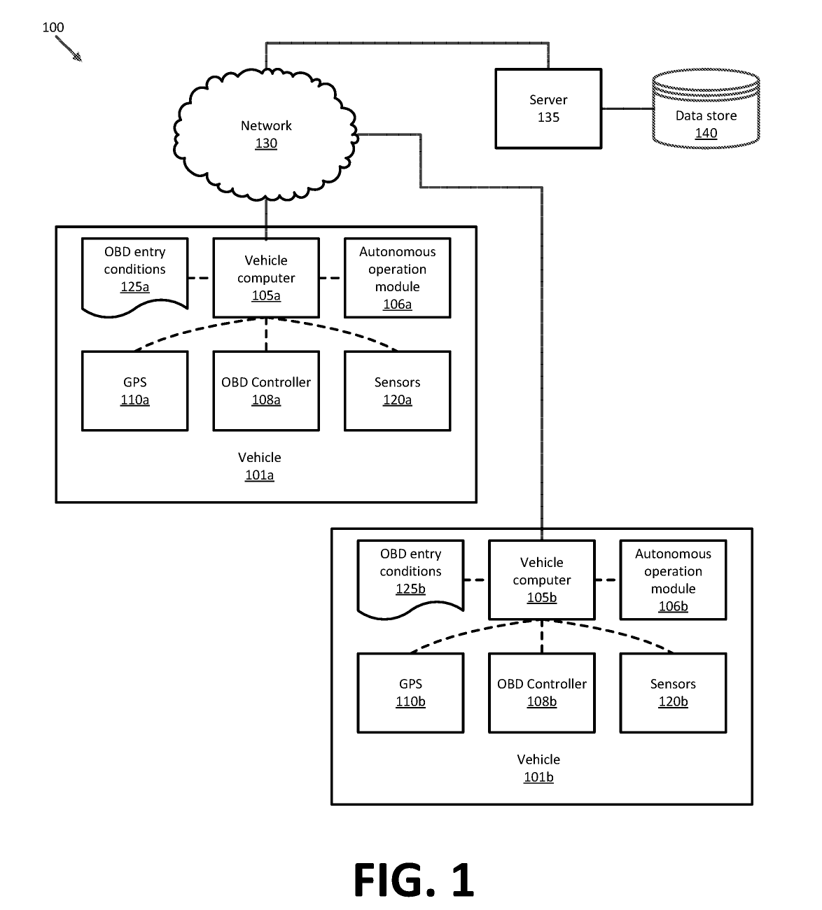

FIG. 1 is a block diagram of an example system 100 for diagnostic test performance control including a remote computing system and multiple vehicles. Although tests described in the examples herein are onboard diagnostics (OBD) system tests, the disclosed subject matter could be practiced in the context of testing other vehicle systems and/or elements.

Vehicles 101a, 101b respectively include vehicle computers 105a, 105b; autonomous operation modules 106a, 106b; and OBD controllers 108a, 108b. Vehicles 101a, 101b each may respectively include global positioning system (GPS) sensors 110a, 110b and a variety of supplemental sensors 120a, 120b; etc. Vehicles 101a, 101b also each respectively include stored OBD entry conditions 125a, 125b. The vehicles 101a, 101b are in communication, via a network 130, with a server 135. The server 135 is in communication with a data store 140. The server 135 may be a remote or cloud-based computing device.

The system 100 operates to enable relatively robust control of diagnostic testing performance in vehicles. The server 135 generates models, from information from one or more vehicles over time, of the performance of diagnostic testing against vehicle operating conditions, towards identifying conditions where successful performance is expected. After meeting the entry conditions 125a and/or 125b for one or more particular OBD tests, respectively, the vehicles 101a and/or 101b query the server 135 for modeled and/or updated required conditions for expected successful performance of the test(s), and determine whether to perform the test(s) by comparison of any required conditions to expected vehicle operating conditions. Thus, vehicles 101a and/or 101b may avoid initiating diagnostic testing, e.g., OBD testing, even where entry conditions are met, where server 135 has determined successful performance is unlikely, thereby saving energy and increasing operating efficiency.

In the system 100, the server 135 may receive one or more fault messages, concerning the unsuccessful performance of diagnostic tests such as OBD tests, transmitted from one or more vehicles, e.g., vehicle 101a and/or 101b. Such fault messages provide data to the server 135 to indicate an unsuccessful performance of a diagnostic test in the respective vehicle, together with data regarding vehicle operating conditions during the unsuccessful performance of that diagnostic test in that vehicle. The data from such fault messages may be saved in the data store 140. The server 135 generates a model of the performance of the diagnostic test relative to the one or more vehicle operating conditions and determines, relative to a threshold or confidence value stored in or calculated from information in the data store 140, one or more required conditions for an expected successful performance of that diagnostic test. Having identified one or more required conditions for an expected successful performance, the server 135 generates a performance message to identify any respective required conditions for any particular diagnostic test, upon request from a vehicle.

### System Elements

It should be understood that descriptions herein of one of vehicles 101a, 101b, or any of the components thereof, are applicable to the other, respectively, and, thus, are not necessarily repeated herein for all counterpart components. Furthermore, unless noted otherwise herein, operations of each vehicle 101a are similar to those of the vehicle 101b.

Vehicle 101a computer 105a generally includes a processor and a memory, the memory including one or more forms of computer-readable media, and storing instructions executable by the processor for performing various operations, including as disclosed herein. The memory of the computer 105a may further store one or more OBD entry conditions 125a. The memory of the computer 105a also generally receives and stores data from sensors 120a, such as imaging sensors, environmental sensors, vehicle system sensors, etc. In addition, the memory of the computer 105a may store various data, including data relating to a vehicle 101a location provided by the GPS 110a, and other data collected from vehicle 101a controllers, sensors, etc.

Accordingly, the computer 105a is generally configured for communications on a bus such as an Ethernet bus, a controller area network (CAN) bus or any other suitable in-vehicle communications bus such as JASPAR, LIN, SAE J1850, AUTOSAR, MOST, etc., and/or may use other wired or wireless protocols, e.g., Bluetooth, etc. That is, the computer 105a can communicate via various mechanisms that may be provided in the vehicle 101a and/or other devices such as a user device. The vehicle 101a may also include one or more electronic control units specifically for receiving and transmitting diagnostic information such as an onboard diagnostics connector (OBD-II). Accordingly, the computer 105a may also have a connection to an onboard diagnostics connector (OBD-II) port, e.g., according to the J1962 standard. Via the Ethernet bus, CAN bus, OBD-II connector port, and/or other wired or wireless mechanisms, the computer 105a may transmit messages to various devices in a vehicle and/or receive messages from the various devices, e.g., controllers, actuators, sensors, etc. In addition, the computer 105a may be configured for communicating, e.g., with one or more remote servers 135, e.g., via the network 130, which, as described below, may include various wired and/or wireless networking technologies, e.g., cellular, Bluetooth, wired and/or wireless packet networks, etc.

Further, the computer 105a typically includes and/or is communicatively coupled to the OBD controller 108a such as is known for accessing OBD tests as well as determining when prerequisite conditions, e.g., stored OBD entry conditions 125a, are met for various OBD tests, and performing such tests.

Generally included in instructions stored in and executed by the computer 105a is an autonomous driving module 106a. Using data received in the computer 105a, e.g., from various sensors, from a vehicle 101a communications bus, from the server 135, etc., the module 106a may control various vehicle 101a components and/or operations without a driver to operate the vehicle 101a autonomously or semi-autonomously (i.e., control some but not all vehicle 101a operations). For example, the module 106a may be used to regulate vehicle 101a speed, acceleration, deceleration, steering, gear shifts, operation of components such as lights, windshield wipers, etc.

The navigation system, e.g., GPS 110a, is operable to determine geo-coordinates, i.e., latitude and longitude, of the vehicle 101a. GPS 110a may also receive input, e.g., geo-coordinates, a street address or the like, etc. of a location of a target destination of the vehicle 101a. Such input may alternatively or additionally be provided to the computer 105a from a user device in the vehicle 101a or remotely, e.g., via the network 130. A user device may be any one of a variety of computing devices including a processor and a memory, as well as communication capabilities. For example, a user device may be a portable computer, tablet computer, a smart phone, etc. that includes capabilities for wireless communications using IEEE 802.11, Bluetooth, and/or cellular communications protocols. Further, a user device may use such communications capabilities to communicate via the network 130 and also directly with a vehicle computer 105a, e.g., using an in-vehicle communications mechanism, e.g., Bluetooth. Further, the autonomous module 106a may use information from the GPS 110a and/or a user device to generate a route to be followed to an intended destination.

A variety of sensors 120a and other sources may provide data for autonomous or semi-autonomous operation of the vehicle 101a. For example, various controllers in the vehicle 101a may provide data via a controller area network (CAN) bus, e.g., data relating to vehicle speed, acceleration, etc. Further, sensors 120a or the like, GPS 110a, etc., may provide data to the computer 105a, e.g., via a wired or wireless connection. Sensors 120a may include mechanisms such as RADAR, LIDAR, cameras or the like, sonar, a breathalyzer, motion detectors, etc. In addition, sensors 120a could include devices in the vehicle 101a operable to detect a position, change in position, rate of change in position, etc., of vehicle 101a components such as a steering wheel, brake pedal, accelerator, gearshift lever, etc. The sensors 120a may measure values relating to operation of the vehicle 101a and of the surrounding vehicles and environment. For example, the sensors 120a may measure the speed and location of the vehicle 101a, a speed and location of surrounding vehicles relative to the vehicle 101a, and/or values relating to prerequisite conditions for the one or more OBD tests, e.g., altitude, speed, fuel volume, acceleration, temperature, etc.

OBD entry conditions 125a include one or more prerequisite conditions for an OBD test (or tests) in the vehicle 101a, whereupon the vehicle 101a may initiate the OBD test. For example, OBD entry conditions 125a for an OBD test may correspond to, e.g., one or more of a specific time, speed, vehicle path, component status, environmental condition, and/or location (e.g., specific global positioning system coordinates) at which that OBD test is to be performed. The computer 105a and/or OBD controller 108a may initiate the OBD test when the OBD entry conditions 125a—and any required conditions for the expected successful performance of the OBD test, as described herein—are sufficiently met, and may monitor the conditions throughout the ODB test.

The computers 105a, 105b and/or OBD controllers 108a, 108b may abort an OBD test, e.g., if conditions change (e.g., the road becomes rough, precipitation begins, a vehicle component malfunctions, etc.), or if incorrect or inconclusive results are being generated (e.g., as compared to stored baseline or threshold values). According to the principles of the present disclosure, for such unsuccessful performances of OBD tests, vehicles 101a, 101b respectively generate fault messages for the unsuccessfully performed OBD tests, respectively, and transmit the fault messages via, e.g., the network 130 to the server 135. Each such fault messages include an identification of the unsuccessfully performed OBD test and vehicle operating conditions during the test, including environmental conditions, vehicle path conditions, and/or vehicle status conditions.

The server 135 may be remotely located relative to vehicles 101a and 101b, and may be in cloud-based communication with vehicles 101a and 101b. The server 135 may store, e.g., in the data store 140, fault messages corresponding to one or more OBD tests. The server 135 may apply an algorithm such as a support vector machine, neural net, and/or clustering algorithm to create models, respectively, of the performance of the OBD tests relative to the vehicle operating conditions. The server 135 may update any such models with each additional such fault message for the corresponding OBD test, and may store models for multiple OBD tests.

According to the principles of the present disclosure, the server 135 may generate, based on each such model, a diagnostic test performance message for each such OBD test. Each such performance message may include one or more required vehicle operating conditions for an expected successful performance of the corresponding OBD test, the expected successful performance of the OBD test being within a threshold degree of confidence according to the model of the performance of the OBD test. The performance message(s) may be updated over time as the model(s) are updated with additional data from various vehicles. Accordingly, the system of the present disclosure may provide, by way of example, a relative increase in the robustness of initiation of OBD tests and resultant efficiencies, e.g., energy and vehicle computing power and capacity.

For example, at certain temperature differentials between the fuel tank and the ambient temperature for vehicles 101a, 101b, the EVAP test may perform unsuccessfully. Other OBD tests may be inaccurate at certain temperatures as well. According to one or more fault messages transmitted to the server 135 upon such unsuccessful performances of the EVAP or other test, the server 135 may model that test performance relative to the fuel tank temperature, the ambient temperature, and the other vehicle operating conditions, to identify fuel tank temperatures, ambient temperatures, and/or other operating conditions corresponding to an expected successful performance of the EVAP or other corresponding OBD test.

In other example, various OBD tests abort under sudden acceleration or deceleration. According to one or more fault messages transmitted to the server 135 upon such unsuccessful performances of those OBD tests, the server 135 may model the performance of those OBD tests relative to vehicle operating conditions such as actual and predicted vehicle paths, to identify vehicle path characteristics, and/or other operating conditions corresponding to an expected successful performance of those OBD tests, respectively.

Upon a request from a vehicle, such as one of vehicles 101a, 101b, the server 135 may transmit the performance message for an OBD test, via the network 130. Vehicles requesting and utilizing performance messages from the server 135 may overlap or may be distinct from vehicles reporting fault messages to the server 135. Similarly, vehicles may request performance messages and report fault message about overlapping and/or distinct OBD tests. The network 130 represents one or more mechanisms by which a vehicle 101a computer 105a may communicate with a remote server 135. Accordingly, the network 130 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The server 135 may be one or more computer servers, each generally including at least one processor and at least one memory, the memory storing instructions executable by the processor, including instructions for carrying out various of the steps and processes described herein. The server 135 includes or is communicatively coupled to the data store 140 for storing data including one or more models, respectively, of the performance of the OBD tests relative to the vehicle operating conditions, as received from fault messages reported to the server 135.

### Example Processes

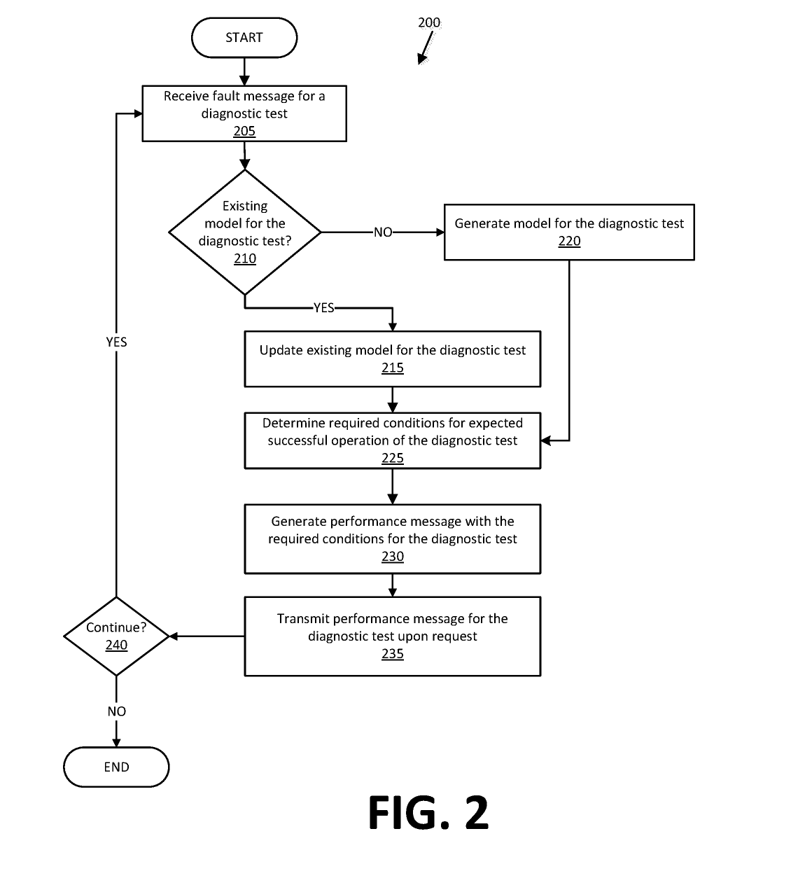

FIG. 2 is a diagram of an example process 200 for generating models of diagnostic testing performance relative to vehicle operating conditions, identifying one or more required conditions under which successful performance of a particular diagnostic test is expected, and for generating performance messages based on the models and any required conditions. The process 200 is described in the context of OBD data and OBD testing by way of example and not limitation; the process 200 could apply to other kinds of data and tests.

The process 200 begins in a block 205 in which the server 135 receives a fault message for a diagnostic test, e.g., an OBD test, transmitted from, e.g., vehicle 101a. The fault message may be received via the network 130 in a known manner. The fault message typically includes data identifying an unsuccessful performance of an OBD test and operating conditions of the vehicle 101a during the unsuccessful performance of the OBD test. For example, the fault message may identify an OBD test which was cut-off due to sudden acceleration or deceleration, along with data collected by various sensors 120a on the vehicle 101a. Examples of collected data from vehicle 101 components such as ECUs, sensors 120a, or the like, include data relating to an environment in which the vehicle 101a is travelling (e.g., ambient light level, presence or absence of precipitation, outside air temperature, etc.), vehicle 101a operating parameters (e.g., vehicle 101 speed, heading, steering angle, activation of brakes, throttle setting, etc.), information concerning upcoming terrain from sensors 120a and/or a navigation system (e.g., rough road, change in elevation, curve, etc.).

Next, in a block 210, the server 135 identifies whether there is an existing model of the performance of that OBD test relative to vehicle operating conditions stored in the data store 140. If so, in a block 215, the existing model for the OBD test is updated with the data from the fault message received at the block 205. If there is no existing model for the OBD test, the server 135, in a block 220, generates a model for the OBD test based on the fault message. The server 135 may model the performance of diagnostic tests relative to vehicle operating conditions through application of one or more known machine learning algorithms, e.g., a support vector machine, a neural net, and/or a clustering algorithm.

Next, in a block 225, from the generated and/or updated model corresponding to the OBD test, the server 135 determines one or more required conditions for the expected successful operation of the OBD test. The server 135 may determine one or more required conditions from the model of the performance of the OBD test, e.g., by comparing data from the model to a threshold or confidence value stored in or calculated from information in the data store 140. For example, for a particular confidence value, the model may predict that the OBD test will successfully perform at or above that confidence level within, e.g., a certain ambient temperature range, and, thus, the server 135 would identify, e.g., the certain ambient temperature range as a required condition for performance of the OBD test.

Next, in the block 230, the server 135 generates a performance message including data to identify the OBD test and the one or more required conditions determined for the OBD test at the block 225. The performance message is configured to be transmitted via the network 130 and received by one or more vehicles 101a, 101b. At a block 235, the server 135 transmits the performance message upon request from one or more vehicles 101a, 101b.

Next, in the block 240, the server 135 determines whether the process 200 should continue. For example, the process 200 may end if the server 135 determines that no vehicles are expected to transmit a fault message or request a performance message. In any case, if the process 200 should not continue the process 200 ends following the block 240. Otherwise, the process 200 returns to the block 205. The process may continue to update the model(s) for the diagnostic test(s), and may generate and update models for multiple diagnostic tests in parallel.

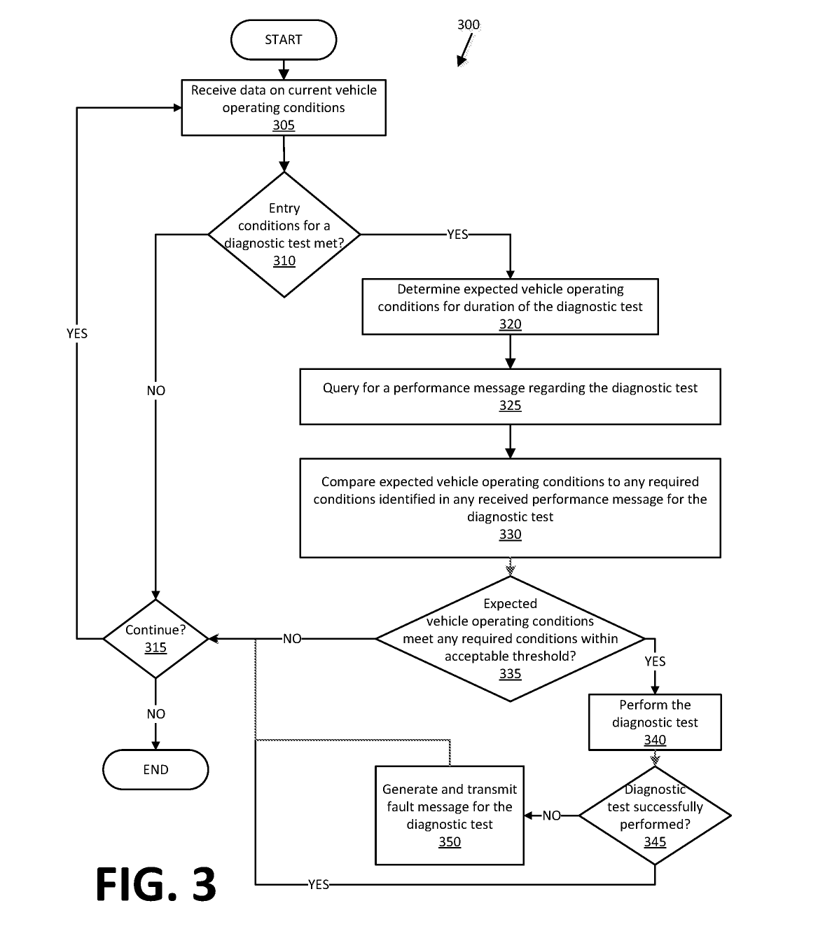

FIG. 3 is a diagram of an example process 300 for controlling diagnostic testing performance in a vehicle. The process 300 is described in the context of OBD data and OBD testing by way of example and not limitation; the process 300 could apply to other kinds of data and tests.

The process 300 begins in a block 305 in which the computer 105a of the vehicle 101a receives data from vehicle 101a components such as ECUs, sensors 120a, or the like, to identify the current operating conditions of the vehicle 101a, e.g., data relating to an environment in which the vehicle 101a is travelling (e.g., ambient light level, presence or absence of precipitation, outside air temperature, etc.), vehicle 101a operating parameters (e.g., vehicle 101 speed, heading, steering angle, activation of brakes, throttle setting, etc.), information concerning upcoming terrain from sensors 120a and/or a navigation system (e.g., rough road, change in elevation, curve, etc.).

Next, in a block 310, the computer 105a determines whether the current vehicle operating conditions meet the OBD entry conditions 125a for one or more OBD test. The computer 105a and/or OBD controller 108a may determine whether OBD entry conditions 125a are met, e.g., by comparing data received at the block 305 to the OBD entry conditions 125a in a known manner. If the OBD entry conditions 125a are not met for any OBD test, the process 300 continues to a block 315, where the computer 105a determines whether the process 300 should continue. For example, the process 300 may end if the computer 105a determines that the vehicle 101a is at or near its destination, or if the vehicle 101a is turned off by a user. In any case, if the process 300 should not continue the process 300 ends following the block 315. Otherwise, the process 300 returns to the block 305.

If, at the block 310, the OBD entry conditions 125a are met for an OBD test in the vehicle 101a, the computer 105a determines, at a block 320, expected vehicle operating conditions for the duration of the OBD test for which the entry conditions 125a have been met. By way of example, such expected vehicle operating conditions to be encountered during a duration of one or more OBD tests of the vehicle 101a may include the vehicle 101a planned route, expected traffic density, outside air temperature, road surface conditions, road friction, vehicle speed, etc.

Next, in a block 325, the computer 105a queries for a performance message corresponding to the OBD test for which the entry conditions 125a have been met. In a block 330, following the query for and/or receipt of such a performance message, e.g., a message transmitted from the server 135 via the network 130, the computer 105a compares the expected vehicle operating conditions determined in the block 320 with any required conditions for the expected successful performance of the OBD test identified in the data of any received performance message for the OBD test for which the entry conditions 125a have been met.

Next, in a block 335, the computer 105a determines whether the expected vehicle operating conditions for the duration of the OBD test (for which the entry conditions 125a have been met) sufficiently meet any required conditions for the expected successful performance of that OBD test as identified in the data of any received performance message. The computer 105a may determine, based on a stored or calculated performance threshold or tolerance, that the expected vehicle operating conditions sufficiently meet the required conditions of the performance message to initiate the OBD test, even if, e.g., all of the required conditions may not be predicted to be met for the entire duration of the OBD test. The performance thresholds or tolerances may depend on the OBD test, the type of vehicle 101a, environmental, path or operating conditions of the vehicle 101a, etc. For example, if the vehicle 101a is predicted to have a speed outside of the required conditions for a relatively brief duration of a lengthy OBD test, the deviation may be within the performance thresholds and/or tolerances, and the computer 105a may determine that performance of the OBD test should proceed.

If the computer 105a determines that the expected vehicle operating conditions do not meet the required conditions within an acceptable performance tolerance of threshold, the computer 105 determines if the process 300 should continue, at the block 315.

In any case, if the computer 105a determines that performance of the OBD test should proceed, the process 300 continues and the computer 105a and/or the OBD controller 108a executes instructs to perform the OBD test, at a block 340. Next, at a block 345, the computer 105a and/or OBD controller 108a determines if the OBD test has been successfully performed. For example, the computer 105a may determine whether the performance of the OBD test was successful, e.g., by comparing stored data for the duration of the OBD test, for a stored range of acceptable results, etc. to the data generated by the OBD test. If the computer 105a determines that the OBD was performed successfully, the computer 105 determines if the process 300 should continue, at the block 315.

If the computer 105a determines that the OBD test was performed unsuccessfully, the computer 105a generates and transmits a fault message for that OBD test. The fault message includes data identifying the unsuccessful performance of the OBD test and operating conditions of the vehicle 101a during the unsuccessful performance of the OBD test. The fault message is configured to be transmitted via the network 130 to, e.g., the server 135, in a known manner. Following the transmission of the fault message, the computer 105a determines if the process 300 should continue, at the block 315.

### CONCLUSION

Computing devices such as those discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. A method, comprising:
receiving a first fault message transmitted from a first vehicle, the first fault message providing data to indicate an unsuccessful performance of a first diagnostic test in the first vehicle and one or more vehicle operating conditions during the unsuccessful performance of the first diagnostic test in the first vehicle;
determining, from the one or more vehicle operating conditions, one or more required conditions for an expected successful performance of the first diagnostic test; and
generating a first performance message, the first performance message providing data to indicate the one or more required conditions for the expected successful performance of the first diagnostic test.

2. The method of claim 1, further comprising:
receiving a second fault message transmitted from a second vehicle, the second fault message providing data to indicate an unsuccessful performance of the first diagnostic test in the second vehicle and one or more vehicle operating conditions during the unsuccessful performance of the first diagnostic test in the second vehicle; and
updating, based on the second fault message, the one or more required conditions for the expected successful performance of the first diagnostic test.

3. The method of claim 1, further comprising:
receiving a second fault message transmitted from the first vehicle, the second fault message providing data to indicate an unsuccessful performance of a second diagnostic test in the first vehicle and one or more vehicle operating conditions during the unsuccessful performance of the second diagnostic test in the first vehicle;
determining, from the second test report message, one or more required conditions for an expected successful performance of the second diagnostic test; and
generating a second performance message, the second performance message providing data to indicate the one or more required conditions for the expected successful performance of the second diagnostic test.

4. The method of claim 1, wherein the one or more required conditions include at least one of an environmental condition and a vehicle path condition.

5. The method of claim 1, wherein determining the one or more required conditions includes modeling the expected successful performance of the first diagnostic test with one of a support vector machine, neural net, and clustering algorithm.

6. The method of claim 1, wherein the first diagnostic test is an onboard diagnostic (OBD) test.

7. A method comprising:
determining that current vehicle operating conditions of a vehicle meet stored entry conditions for initializing a first diagnostic test, the first diagnostic test having a first duration;
determining expected vehicle operating conditions of the vehicle for the first duration;
querying a remote computing device for a first performance message;
receiving the first performance message, the first performance message providing data to indicate one or more required conditions for an expected successful performance of the first diagnostic test;
comparing the expected vehicle operating conditions of the vehicle for the first duration to the one or more required conditions from the first performance message; and
determining, based on the comparison, whether to perform the first diagnostic test.

8. The method of claim 7, further comprising:
determining an unsuccessful performance of the first diagnostic test;
generating a fault message, the fault message providing data to indicate the unsuccessful performance of the first diagnostic test and one or more vehicle operating conditions during the unsuccessful performance of the first diagnostic test; and
transmitting the fault message to the remote computing device.

9. The method of claim 7, wherein the one or more required conditions include at least one of an environmental condition and a vehicle path condition.

10. The method of claim 7, wherein the first diagnostic test is an onboard diagnostic (OBD) test.

11. The method of claim 7, wherein the remote computing device is a cloud-based server.

12. A system, comprising:
a computer comprising a processor and a memory, the memory storing instructions executable by the processor to:
receive a first fault message transmitted from a first vehicle, the first fault message providing data to indicate an unsuccessful performance of a first diagnostic test and one or more vehicle operating conditions during the unsuccessful performance of the first diagnostic test;
determine, from the one or more vehicle operating conditions, one or more required conditions for an expected successful performance of the first diagnostic test; and
generating a first performance message, the first performance message providing data to indicate the one or more required conditions for the expected successful performance of the first diagnostic test.

13. The system of claim 12, wherein the memory stores further instructions executable by the processor to:
receive a second fault message transmitted from a second vehicle, the second fault message providing data to indicate an unsuccessful performance of the first diagnostic test in the second vehicle and one or more vehicle operating conditions during the unsuccessful performance of the first diagnostic test in the second vehicle; and
update, based on the second fault message, the one or more required conditions for the expected successful performance of the first diagnostic test.

14. The system of claim 12, wherein the memory stores further instructions executable by the processor to:
receive a second fault message from the first vehicle, the second fault message providing data to indicate an unsuccessful performance of a second diagnostic test in the first vehicle and one or more vehicle operating conditions during the unsuccessful performance of the second diagnostic test in the first vehicle;
determine, from the second fault message, one or more required conditions for an expected successful performance of the second diagnostic test; and
generating a second performance message, the second performance message providing data to indicate the one or more required conditions for the expected successful performance of the second diagnostic test.

15. The system of claim 12, wherein the one or more required conditions for the expected successful performance of the first diagnostic test include at least one of an environmental condition and a vehicle path condition.

16. The system of claim 15, where the environmental condition is one of an ambient temperature and a precipitation condition.

17. The system of claim 15, wherein the vehicle path condition is one of a vehicle acceleration and a vehicle deceleration.

18. The system of claim 12, wherein determining the one or more required conditions for the expected successful performance of the first diagnostic test includes modeling the expected successful performance of the first diagnostic test with one of a support vector machine, neural net, and clustering algorithm.

19. The system of claim 12, wherein the first diagnostic test is an onboard diagnostic (OBD) test.

20. The system of claim 12, wherein the computer is a cloud-based server.
